(19) United States
(12) Patent Application Publication
(10) Pub. No.: US 2014/0181553 A1
(43) Pub. Date: Jun. 26, 2014

(54) Idle Phase Prediction For Integrated Circuits

(71) Applicant: ADVANCED MICRO DEVICES, INC., Sunnyvale, CA (US)

(72) Inventors: Yasuko Eckert, Kirkland, WA (US); Srilatha Manne, Portland, OR (US); William L. Bircher, Austin, TX (US); Mahdu S.S. Govindan, Austin, TX (US); Michael J. Schulte, Austin, TX (US)

(73) Assignee: ADVANCED MICRO DEVICES, INC., Sunnyvale, CA (US)

(21) Appl. No.: 13/723,868

(22) Filed: Dec. 21, 2012

(51) Int. Cl. G06F 1/32

(52) U.S. Cl. CPC G06F 1/3234
USPC 713/323

(57) ABSTRACT

A method and apparatus for idle phase prediction in integrated circuits is disclosed. In one embodiment, an integrated circuit (IC) includes a functional unit configured to cycle between intervals of an active state and an idle state. The IC further includes a prediction unit configured to record a history of idle state durations for a plurality of intervals of the idle state. Based on the history of idle state durations, the prediction unit is configured to generate a prediction of the duration of the next interval of the idle state. The prediction may be used by a power management unit to, among other uses, determine whether to place the functional unit in a low power (e.g., sleep) state.

### BACKGROUND

1. Technical Field

This disclosure relates to integrated circuits, and more particularly managing power consumption of integrated circuits.

2. Description of the Related Art

Managing power consumption in integrated circuits (ICs) such as computer system processors and various types of system-on-a-chip (SoC) ICs is increasingly important. This is true not only during times when an IC is actively performing work, but also during times when the IC is idle. In particular, the small feature sizes of transistors in ICs can result in leakage currents and thus power consumption even in functional units that are otherwise not performing any work.

When a functional unit of an IC becomes idle, power management hardware or software may take various actions to reduce power consumption. Reducing clock frequencies or gating clocks may reduce dynamic power consumption. Reducing a supply voltage may provide additional reductions in power consumption. In some cases, a functional unit may be power gated (i.e. may have power removed therefrom) when it is idle. This may be referred to as a deep sleep state.

Entry into a low power or sleep state may be accomplished by performing various actions. Consider for example an SoC having multiple processor cores and a power management unit implemented thereon. Actions performed in placing a processor core into a sleep state may include flushing any caches that will lose power, turning off power from phase locked loops (PLLs), saving system states, and so forth. Upon entry into the low power or sleep state, the processor core may remain there until an external interrupt or other action that causes initiation of a wake-up of the core.

### SUMMARY OF EMBODIMENTS OF THE DISCLOSURE

A method and apparatus for idle phase prediction in integrated circuits is disclosed. In one embodiment, a method includes recording a history of idle state durations for a plurality of intervals of the idle state, and predicting a duration of a next interval of the idle state based on the history of idle state durations.

In one embodiment, an IC includes a functional unit configured to cycle between intervals of an active state and intervals of an idle state. The IC further includes a prediction unit configured to record a history of idle state durations for a plurality of intervals of the idle state. The prediction unit is further configured to predict a duration of the next interval of the idle state based on the history of idle state durations.

### BRIEF DESCRIPTION OF THE DRAWINGS

Other aspects of the disclosure will become apparent upon reading the following detailed description and upon reference to the accompanying drawings, which are now briefly described.

FIG. 1 is a block diagram of one embodiment of an integrated circuit (IC).

FIG. 2 is a diagram illustrating the operation of a functional unit in one embodiment of an IC.

FIG. 3 is a block diagram illustrating one embodiment of a power management unit and one embodiment of a prediction unit coupled thereto.

FIG. 4 includes a number of histograms to illustrate binning approaches used by various embodiments of a prediction unit.

FIG. 5 is a flow diagram illustrating one embodiment of a method for predicting an idle state duration based on an average.

FIG. 6 is a flow diagram illustrating one embodiment of a method for predicting an idle state duration based on a determination of a fastest growing bin.

FIG. 7 is a flow diagram illustrating one embodiment of a method for predicting an idle state duration based on a bimodal distribution of idle state durations.

FIG. 8 is a flow diagram illustrating one embodiment of a method for predicting idle state duration based on a pair of bins separated by a threshold.

FIG. 9 is a flow diagram illustrating one embodiment of a method for using a binning approach to predict an active time for a functional unit of an IC.

FIG. 10 is a block diagram illustrating one embodiment of a computer readable storage medium.

While the subject matter disclosed herein is susceptible to various modifications and alternative forms, specific embodiments thereof are shown by way of example in the drawings and will herein be described in detail. It should be understood, however, that the drawings and description thereto are not intended to be limiting to the particular form disclosed, but, on the contrary, is to cover all modifications, equivalents, and alternatives falling within the spirit and scope of the present disclosure as defined by the appended claims.

### DETAILED DESCRIPTION

### Overview

The present disclosure is directed to various methods for predicting a duration of a next idle state for a functional unit of an IC based on a history of durations of prior idle states. The prediction information may be used for various purposes, including (but not limited to) deciding whether to allow the functional unit to enter certain low power states (e.g., a sleep state) as well as when to exit such low power states.

In an exemplary embodiment, an IC may be a system-on-a-chip (SoC) having a number of processor cores. The SoC may include a prediction unit configured to monitor the activity of the processor cores to determine if any have entered the idle state. The idle state may be generally defined as a state wherein a functional unit of an IC is not performing work. In the case of a processor core, the idle state may be defined in various ways, such as a state in which the processor core is not executing any instructions. The prediction unit may include a timer that determines an amount of time that the processor core is in the idle state, with the timer being reset upon the processor core resuming operation in an active state (e.g., processing instructions). When a given interval of the idle state ends, the prediction unit may record the duration of that interval. The prediction unit may also subdivide the duration history of a most recent N intervals of the idle state (where N is an integer number greater than one) into bins. Using the information as indicated by the bins, the prediction unit may generate a prediction of the duration for a next idle state.

Various approaches may be used to generate predictions based on the idle state duration history. Example approaches include computing an average idle state duration and basing a prediction thereon, basing a prediction on a bin having a fastest growing count, basing a prediction on a larger of two bins when the historical distribution of idle state times is bimodal, and so forth. As noted above, such predictions may be used to determine whether or not to enter low power states during idle times. For example, using a prediction of idle state time, a power management unit may determine if entry into a sleep (i.e., power gated) state does not result in an undue amount of performance loss based on the energy savings obtainable in the predicted idle time.

System-on-a-Chip (SoC) with Power Management Unit and Operation Thereof:

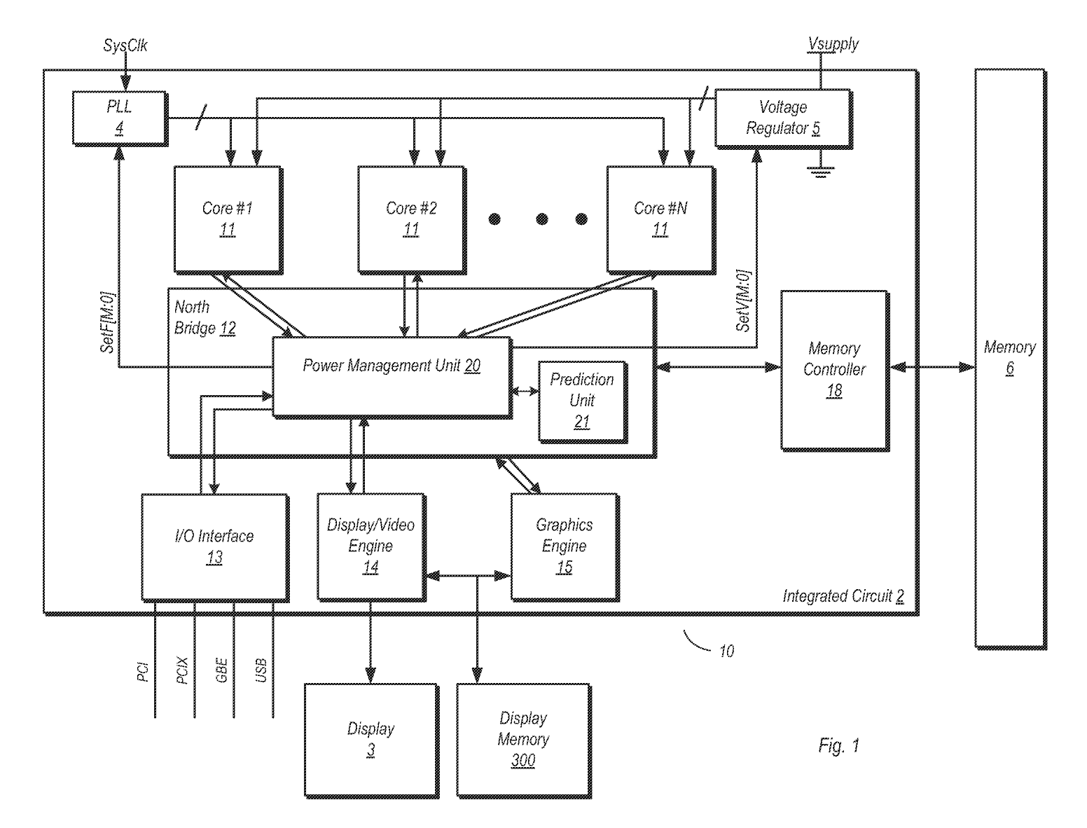

FIG. 1 is a block diagram of one embodiment of an integrated circuit (IC) coupled to a memory. IC2 and memory 6, along with display 3 and display memory 300, form at least a portion of computer system 10 in this example. In the embodiment shown, IC 2 is a system-on-a-chip (SoC) having a number of processing nodes 11. Processing nodes 11 are processor cores in this particular example, and are thus also designated as Core #1, Core #2, and so forth. It is noted that the methodology to be described herein may be applied to other arrangements, such as multi-processor computer systems implementing multiple processors (which may be single-core or multi-core processors) on separate, unique IC dies. Furthermore, embodiments having only a single processing node 11 are also possible and contemplated.

Each processing node 11 is coupled to north bridge 12 in the embodiment shown. North bridge 12 may provide a wide variety of interface functions for each of processing nodes 11, including interfaces to memory and to various peripherals. In addition, north bridge 12 includes a power management unit 20 that is configured to manage the power consumption of each of processing nodes 11. It is noted that power management unit 20 may be implemented in a location external to north bridge 12 in some embodiments. The power management functions performed by power management unit 20 is the determination of whether to enter various low power states based on the activity level of processing nodes 11. For example, if a processing node 11 is idle, power management unit 20 may reduce the voltage supplied thereto and or reduce the frequency of a clock signal provided thereto. Moreover, if a given processing node 11 is idle for a sufficient amount of time, power management unit 20 may place it into a sleep state by gating (i.e. turning off) both the clock signal and the power provided thereto. Power management unit 20 may provide various signals to a processing node 11 prior to gating power and clock signals provided thereto in order to enable it to perform actions such as flushing caches, saving states, and so forth.

In the embodiment shown, north bridge 12 includes a prediction unit 21 coupled to power management unit 20. Prediction unit 21 is configured to store and analyze information related to the history of previous idle states for each of the processor cores 11, and may also store information related to the history of previous active states. In particular, prediction unit 21 may store information regarding respective durations of a number of previously occurring idle states for each processor core 11. Prediction unit 21 and may store information regarding respective durations of a number of previously occurring active states for each processor core 11. The duration information for each processor core may be arranged in bins, as is discussed further below. Using the information duration for the idle states, prediction unit 21 may predict the duration of the next idle state for each of the processor cores 11.

Using the predictions made by prediction unit 21, power management unit 20 may determine whether to place a processor core 11 into a low power state responsive to determining that it is idle. A low power state as defined herein may be a state in which a voltage supplied to processor core is reduced from its maximum, a state in which the frequency of the clock signal is reduced, a state in which the clock signal is inhibited from a processor core (clock-gated), one in which power is removed from a processor core (power gated), or a combination of any of the former. A low power state in which both clock and power are removed from a processor core may be referred to as a sleep state.

Since there is overhead in entering a low power state in terms of energy costs and performance costs, power management unit 20 may use the prediction to determine if entry into a low power state may provide power savings at or beyond a break-even point. For example, entry into a sleep state may require flushing of one or more caches, saving a processor state, powering down PLLs, and so on. Upon exit from a sleep state, PLLs may require a warm-up period before fully operating. Restoration of a previous state may also be required upon exit from a sleep state. Cache misses may also occur frequently upon re-commencing operations following the exit from a sleep state. Accordingly, entry into a sleep state (and more generally, entry into a low power state) incurs various costs. If prediction unit 21 predicts that a next idle state may be of a short duration, power management unit 20 may forgo entry into a low power state, as the costs incurred in doing so may outweigh the benefit of the power savings that may be obtained. Conversely, if prediction unit 21 predicts that the next idle state may be of a long duration, the power savings obtained by entry into a low power/sleep state may outweigh costs of entry into that state. Thus, in the latter case, power management unit 20 may place an idle processor core 11 into a low power/sleep state responsive to determining that the core is idle and its predicted idle duration is long enough to justify the costs.

As noted above, prediction unit 21 may also predict active state times. Power management unit 20 and/or an affected processor core 11 may use predicted active state times to optimize performance and power consumption. For example, if prediction unit 21 predicts that a given processor core 11 will be active for only a short time, power management unit 20 may cause only a portion of the caches within that core to be enabled, as it is less likely that the full cache will be needed for that instance of the active state. For longer predicted active state durations, a larger portion of the cache may be enabled.

In addition to maintaining historical data for previous idle (and in some cases, active) state duration, prediction unit 21 may also maintain a history of prediction accuracy. This may be used to generate confidence metrics regarding future predictions, and may also provide feedback to adjust future predictions accordingly.

In various embodiments, the number of processing nodes 11 may be as few as one, or may be as many as feasible for implementation on an IC die. In multi-core embodiments, processing nodes 11 may be identical to each other (i.e. homogenous multi-core), or one or more processing nodes 11 may be different from others (i.e. heterogeneous multi-core). Processing nodes 11 may each include one or more execution units, cache memories, schedulers, branch prediction circuits, and so forth. Furthermore, each of processing nodes 11 may be configured to assert requests for access to memory 6, which may function as the main memory for computer system 10. Such requests may include read requests and/or write requests, and may be initially received from a respective processing node 11 by north bridge 12. Requests for access to memory 6 may be routed through memory controller 18 in the embodiment shown.

I/O interface 13 is also coupled to north bridge 12 in the embodiment shown. I/O interface 13 may function as a south bridge device in computer system 10. A number of different types of peripheral buses may be coupled to I/O interface 13. In this particular example, the bus types include a peripheral component interconnect (PCI) bus, a PCI-Extended (PCI-X), a PCIE (PCI Express) bus, a gigabit Ethernet (GBE) bus, and a universal serial bus (USB). However, these bus types are exemplary, and many other bus types may also be coupled to I/O interface 13. Peripheral devices may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O unit 13 via a corresponding peripheral bus may assert memory access requests using direct memory access (DMA). These requests (which may include read and write requests) may be conveyed to north bridge 12 via I/O interface 13, and may be routed to memory controller 18.

In the embodiment shown, IC 2 includes a display/video engine 14 that is coupled to display 3 of computer system 10. Display 3 may be a flat-panel LCD (liquid crystal display), plasma display, a CRT (cathode ray tube), or any other suitable display type. Display/video engine 14 may perform various video processing functions and provide the processed information to display 3 for output as visual information. Some video processing functions, such as 3-D processing, processing for video games, and more complex types of graphics processing may be performed by graphics engine 15, with the processed information being relayed to display/video engine 14 via north bridge 12.

In this particular example, computer system 10 implements a non-unified memory architecture (NUMA) implementation, wherein video memory and RAM are separate from each other. In the embodiment shown, computer system 10 includes a display memory 300 coupled to display/video engine 14. Thus, instead of receiving video data from memory 6, video data may be accessed by display/video engine 14 from display memory 300. This may in turn allow for greater memory access bandwidth for each of cores 11 and any peripheral devices coupled to I/O interface 13 via one of the peripheral buses.

In the embodiment shown, IC 2 includes a phase-locked loop (PLL) unit 4 coupled to receive a system clock signal. PLL unit 4 may include a number of PLLs configured to generate and distribute corresponding clock signals to each of processing nodes 11. In this embodiment, the clock signals received by each of processing nodes 11 are independent of one another. Furthermore, PLL unit 4 in this embodiment is configured to individually control and alter the frequency of each of the clock signals provided to respective ones of processing nodes 11 independently of one another. As will be discussed in further detail below, the frequency of the clock signal received by any given one of processing nodes 11 may be increased or decreased in accordance with performance demands imposed thereupon. The various frequencies at which clock signals may be output from PLL unit 4 may correspond to different operating points for each of processing nodes 11. Accordingly, a change of operating point for a particular one of processing nodes 11 may be put into effect by changing the frequency of its respectively received clock signal.

In the case where changing the respective operating points of one or more processing nodes 11 includes the changing of one or more respective clock frequencies, power management unit 20 may change the state of digital signals SetF[M:0] provided to PLL unit 4. Responsive to the change in these signals, PLL unit 4 may change the clock frequency of the affected processing node(s). Additionally, power management unit 20 may also cause PLL unit 4 to inhibit a respective clock signal from being provided to a corresponding one of processing nodes 11.

In the embodiment shown, IC 2 also includes voltage regulator 5. In other embodiments, voltage regulator 5 may be implemented separately from IC 2. Voltage regulator 5 may provide a supply voltage to each of processing nodes 11. In some embodiments, voltage regulator 5 may provide a supply voltage that is variable according to a particular operating point (e.g., increased for greater performance, decreased for greater power savings). In some embodiments, each of processing nodes 11 may share a voltage plane. Thus, each processing node 11 in such an embodiment operates at the same voltage as the other ones of processing nodes 11. In another embodiment, voltage planes are not shared, and thus the supply voltage received by each processing node 11 may be set and adjusted independently of the respective supply voltages received by other ones of processing nodes 11. Thus, operating point adjustments that include adjustments of a supply voltage may be selectively applied to each processing node 11 independently of the others in embodiments having non-shared voltage planes. In the case where changing the operating point includes changing an operating voltage for one or more processing nodes 11, power management unit 20 may change the state of digital signals SetV[M:0] provided to voltage regulator 5. Responsive to the change in the signals SetV[M:0], voltage regulator 5 may adjust the supply voltage provided to the affected ones of processing nodes 11. In instances in power is to be removed from (i.e., gated) from one of processing nodes 11, power management unit 20 may set the state of corresponding ones of the SetV[M:0] signals to cause voltage regulator 5 to provide no power to the affected processing node 11.

It should be noted that embodiments are possible and contemplated wherein the various units discussed above are implemented on separate IC's. For example, one embodiment is contemplated wherein cores 11 are implemented on a first IC, north bridge 12 and memory controller 18 are on another IC, while the remaining functional units are on yet another IC. In general, the functional units discussed above may be implemented on as many or as few different ICs as desired, as well as on a single IC. It is further noted that while the discussion above has focused on a particular embodiment of an SoC, the various methodologies described herein may be used with any IC that implements power management functions.

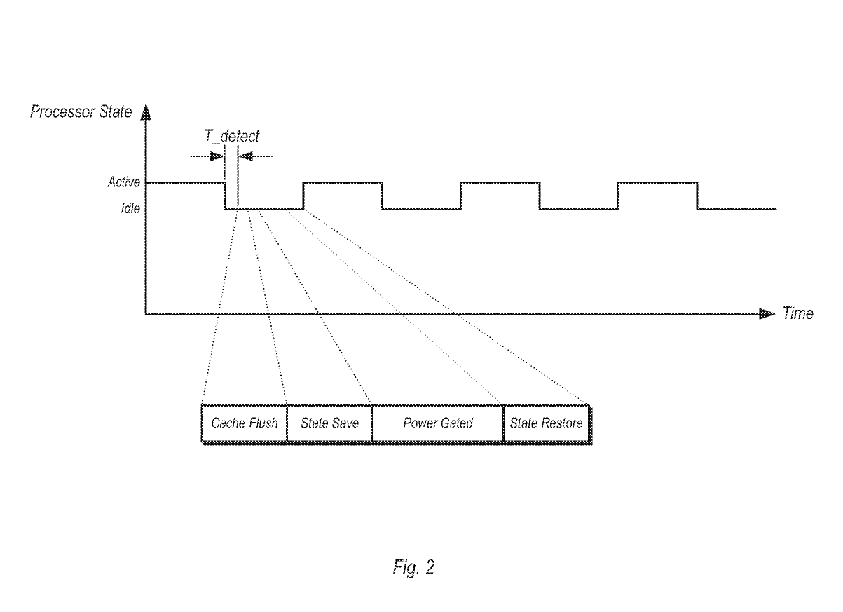

FIG. 2 is a diagram illustrating the operation of a processor core in the embodiment of IC 2 shown above. As shown in FIG. 2, operation of a processor core 11 may cycle between intervals of an active state and intervals of an idle state. During operation in the active state, the processor core is processing instructions and doing other useful work. When in the idle state, the processor core 11 is not processing instructions or performing any useful work. If the time in the idle state is sufficient, it may be beneficial to place the processor core 11 in a low power state, or even in a sleep state. In the sleep state, the processor core may be power gated, i.e., power may be removed therefrom. Typically, the processor core 11 is also clock gated in the sleep state.

A sequence of events involving entry to and exit from the sleep state are shown in FIG. 2. Before any action is performed to place the processor core 11 in the sleep state, the processor core 11 is first determined to be idle. In the example shown, the determination that the processor core 11 is idle may be made by detecting that no useful work or other activity has been performed by processor core 11 for a time T_detect. Once this threshold has been crossed, power management unit 20 may determine that the processor core 11 is to be placed in the sleep state.

Prior to removing power from a processor core 11, any caches implemented therein are flushed. Flushing a cache comprises writing back to main memory and/or a lower level cache any modified data residing therein. Cache flushing is thus performed to maintain coherency of memory contents. In some cases, saving of the state of processor core 11 (‘state save’) may also be performed. Saving the state of the processor core 11 may include saving the state of various registers, data stored in various retention flops, and so forth. This information may be saved into another memory external to processor core 11. Once the cache flush and state save operations are complete, power may be removed from processor core 11 to place it into the sleep state. After restoring power to the processor core 11 upon exit from the sleep state, the saved state may be restored. Upon restoration of the saved state, processor core 11 may resume operation in the active state.

### Prediction Unit and Power Management Unit:

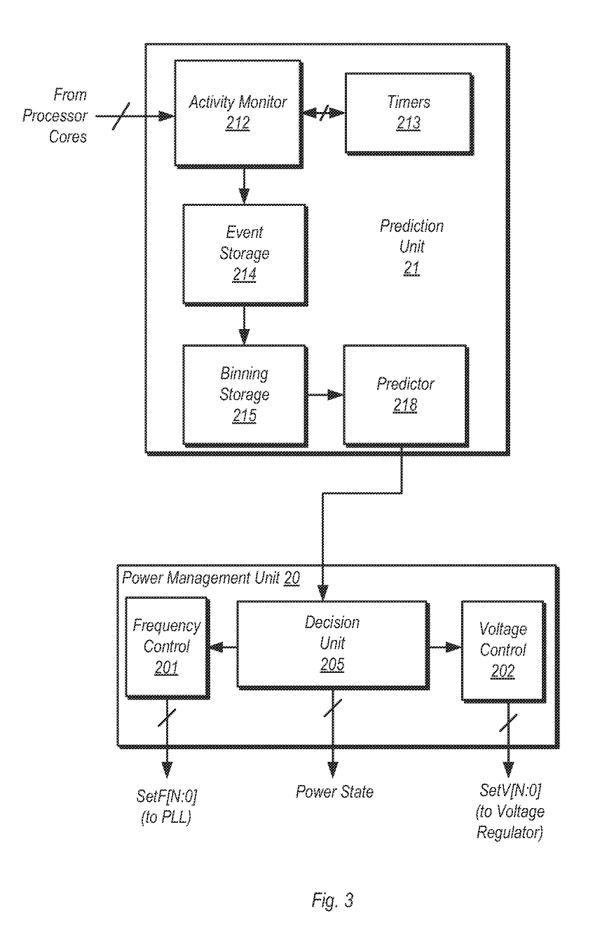

Turning now to FIG. 3, a block diagram illustrating one embodiment of a prediction unit 21 and an embodiment of a power management unit 20 is shown. In the embodiment shown, prediction unit 21 includes an activity monitor 212 coupled to receive indications of activity from the various processor cores 11. In a more generalized embodiment, activity monitor 212 may be coupled to receive activity indications from various different types of functional units implemented on an IC. Returning to this particular embodiment, the types of activity monitored by activity monitor 212 may include (but are not limited to) instructions executed, instructions retired, memory requests, and so on. In addition, one or more types of activity may be monitored by activity monitor 212.

Prediction unit 21 in the embodiment shown includes a plurality of timers 213 (shown here as a single block encompassing each of the timers). One timer 213 may be included for each of the functional blocks for which activity is to be monitored. Each of the timers 213 may be reset when activity is detected from its corresponding processor core by activity monitor 212. After being reset, a given timer 213 may begin tracking the time since the most recent activity. Each timer 213 may report the time since activity was most recently detected in its corresponding processor core 11. After the time since the most recent activity has reached a certain threshold for a given processor core 11, activity monitor 212 may indicate that the given core is idle. Activity monitor 212 may further continue to record the time that the processor core 11 is idle, based on the time value received from the corresponding timer 213, until the core resumes activity.

It is noted that, as an alternative to implementing activity monitor 212, entry into an idle state may be determined responsive to a halt instruction from the operating system. In generally, any suitable mechanism can be used to determine if a processor core 11 (or more generally, a functional unit) is idle, and such mechanisms may be implemented using hardware, software, or any combination thereof.

Once a processor core 11 has resumed activity after being determined to have been in the idle state, activity monitor 212 may record the duration of the idle state in that core in event storage 214. In the embodiment shown, event storage 214 may store the duration for each the most recent N instances of the idle state for each of the processor cores 11 for which idle state times are being monitored. In one embodiment, event storage 214 may include a plurality of first-in, first-out (FIFO) memories, one for each processor core 11. Each FIFO in event storage 214 may store the duration of the most recent N instances of the idle state for its corresponding processor core 11. As a durations new instances of idle states are recorded in a FIFO corresponding to a given core, the durations for the oldest idle state instances may be overwritten.

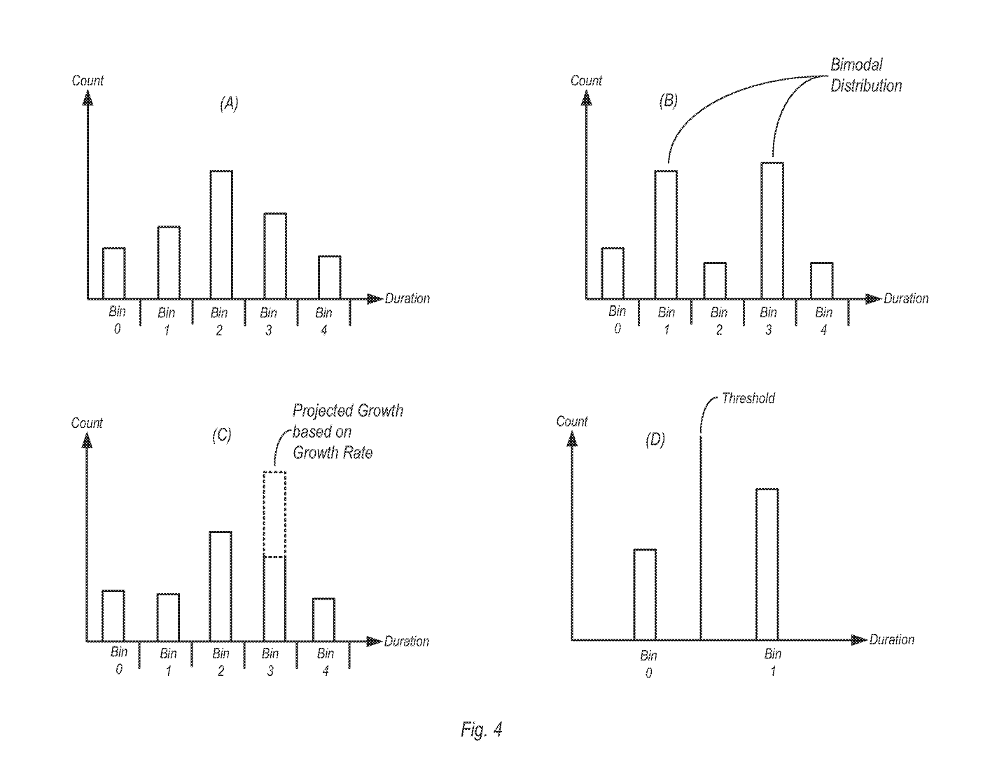

Binning storage 215 is coupled to event storage 214, and may, for each processor core 11, store counts of idle state durations in corresponding bins in order to generate a distribution of idle state durations. Binning storage 215 may include logic to read the recorded durations from event storage 214 and may generate the count values for each bin. As old duration data is overwritten by new duration with the occurrence of additional instances of the idle state, the logic in binning storage 215 may update the count values in the bins. The binning methodology is further illustrated below in reference to FIG. 4.

Predictor 218 is coupled to binning storage 215. Based on the distribution of idle state durations for a given processor core 11, predictor 218 may generate a prediction as to the duration of the next idle state. Various methodologies may be used to generate the prediction, and these methodologies are discussed in further detail below.

In addition to predictions for the duration of the idle state, predictor 218 may also generate indications for predetermined times at which low power states may be exited based on the idle state duration predictions. For example, in one embodiment, if a processor core 11 is placed in a sleep state (i.e. power and clock both removed therefrom) during an instance of the idle state, power management unit 20 may cause that core to exit the sleep state at a predetermined time based on the predicted idle state duration. This exit from the sleep state may be invoked without any other external event (e.g., an interrupt from a peripheral device) that would otherwise cause an exit from the sleep state. Moreover, the exit from the sleep state may be invoked before the predicted duration of the idle state has fully elapsed. If the prediction of idle state duration is reasonably accurate, the preemptive exit from the sleep state may provide various performance advantages. For example, the restoring of a previously stored state may be performed between the time of the exit from the sleep state and the resumption of the active state, thus enabling the processor core 11 to begin executing instructions faster than it might otherwise be able to do so in the case of a reactive exit from the sleep state.

Predictions made by predictor 218 may be forwarded to decision unit 205 of power management unit 20. In the embodiment shown, decision unit 205 may use the prediction of idle state time, along with other information, to determine whether to place an idle processor core 11 in a low power state. Additionally, decision unit 205 may determine what type of low power state the idle processor core is to be placed. For example, if the predicted idle duration is relatively short, decision unit 205 may reduce power consumption by reducing the frequency of a clock signal provided to the processor core 11, reducing the voltage supplied to the processor core 11, or both. In another example, if the predicted idle duration is long enough such that it exceeds a break-even point, decision unit 205 may cause the idle processor core 11 to be placed in a sleep state in which neither power nor an active clock signal are provided to the core. Responsive to determining which power state a processor core 11 is to be placed, decision unit 205 may provide power state information (‘Power State’) to that core. A processor core 11 receiving updated power state information from decision unit 205 may perform various actions associated with entering the updated power state (e.g., a state save in the event that the updated power state information indicates that the processor core 11 will be entering the sleep state).

Power management unit 20 in the embodiment shown includes a frequency control unit 201 and a voltage control unit 202. Frequency control unit 201 is configured to generate control signals for adjusting the frequency of the clock signals provided to each of the processor cores 11. The frequency of a clock signal provided to a given one of processor cores 11 may be adjusted independently of the clock signals provided to the other cores. The frequency control signals may be provided to PLL unit 4. In addition to changing the frequency of a clock signal, frequency control signals may also cause PLL unit 4 to inhibit a clock signal (‘clock gate’) from being provided to a selected one of processor cores 11. Voltage control unit 202 in the embodiment shown is configured to generate control signals provided to voltage regulator 5 for independently adjusting the respective supply voltages received by each of the processor cores 11. Voltage control signals may be used to reduce a supply voltage provided to a given processor core 11, increase a supply voltage provided to that core, or to turn off that core by inhibiting it from receiving any supply voltage. Both frequency control unit 201 and voltage control unit 202 may generate their respective control signals based on information provided to them by decision unit 205.

### Binning of Duration Data:

FIG. 4 includes a number of histograms to illustrate binning approaches used by various embodiments of a prediction unit. Various embodiments of the hardware discussed above may utilize any of the binning approaches discussed below. Furthermore, some embodiments may switch binning approaches based on various factors such as user inputs and operating conditions. It is further noted that the alternatives to the various embodiments discussed above may be implemented partly or wholly in software, and may thus fall within the scope of this disclosure.

The horizontal axis for each of the illustrated examples is divided into bins that cover a specified duration. The spacing of the bins may be linear or logarithmic in various embodiments. In some embodiments, the spacing of the bins may be dynamically adjustable based on factors such as previous history or break-even points for entering low power states. The vertical axis in each of the illustrated examples represents a count of incidents of idle durations. Thus, the data in each bin represents a count of the number of incidents of idle durations falling within the range represented by that particular bin.

In example (A) of FIG. 4, the distribution of idle state duration history shows that the range represented by Bin 2 has the greatest number of incidents, with Bin 3 having the next greatest number. A prediction unit as described above could use the data shown in (A) to predict that the duration of the next idle state will fall within to the range represented by Bin 2. Alternatively, a prediction unit could compute an average idle state duration based on the data shown in (A) and use that average as a basis to predict the duration of the next idle state. In some cases, when averaging is performed, bins having counts below a certain threshold may be ignored. For example, in (A), if the count values in Bin 0 and Bin 4 are below a threshold, they may be ignored, and the average may be computed based on the data present in Bins 1, 2, and 3.

In (B), the distribution of idle state times if bimodal. That is, Bins 1 and 3 each show significantly greater counts than Bins 0, 2, and 4. In cases of a bimodal distribution, a prediction unit may predict the next idle state duration to fall into the range corresponding to the bin representing the greater duration, which is Bin 3 in this case. Using the example shown here, if upon entry into the next idle state, the duration thereof extends beyond the range represented by Bin 1, it is likely that the final duration will fall within the range represented by Bin 3, based on the historical distribution. In general, when a bimodal distribution occurs, one embodiment of a prediction unit may base its prediction of the next idle state duration on the bin representing the greater range of durations. Other embodiments of a prediction unit may incorporate additional factors in determining which of the two bins in a bimodal distribution should be the basis for predicting the duration of the next idle state.

In (C), Bin 2 has the highest count of idle state durations, while Bin 3 has the fastest growing count of idle state durations (as represented by the dashed lines marked ‘Projected Growth based on Growth Rate’). In one embodiment, a prediction unit may use both the event storage and the binning storage to determine the growth rate for each bin. In such an embodiment, a prediction may base a prediction on the bin having the fastest growth rate, which can in some instances be different from the bin having the greatest count value. In the example illustrated in (C), a prediction unit may predict that the duration of the next idle state is within the range specified by Bin 3, which has the fastest growth rate, rather than Bin 2, which indicates an overall greater number of incidents. Predicting the duration of the next idle state in this manner may thus give extra weight to more recent history and thus provide quicker adaptation to changing operating conditions. In embodiments enabled to determine the bin having the fastest growing count value, the prediction unit may implement the ability to track the rates of growth (and decline) for the counts in each of the bins.

In (D), only two bins are present. These two bins are separated by a threshold value, which may be static in some embodiments and dynamic in other embodiments. The threshold that separates the two bins may be based on an energy break-even point used to determine if there is a net benefit to entering a low power state, such as a sleep state. Using this binning approach, a prediction unit may make a binary prediction as to whether the duration of the next idle state will be greater than the duration threshold separating the two bins. Moreover, the prediction may be based on which bin has the greater count value. In this particular example, Bin 1 has the greater count value, and thus the next idle state may be predicted to have a duration that exceeds the threshold.

An alternative to the approach described in (D) could incorporate the approach described in (C). That is, the prediction unit could make a prediction as to whether the next idle state duration will exceed the threshold based on which of the two bins is the fastest growing. In yet another alternative approach, both the raw count and their respective rates of growth/decline could also be considered, with extra weight given to one of those factors.

Generally speaking, any of the various approaches to making predictions based on the binning of results may be implemented by a prediction unit. Furthermore, these approaches may be combined in various ways, such as the combination of approaches (C) and (D) discussed above. Using one of the various approaches discussed above, various combinations thereof, or other approaches utilizing binning not discussed herein, a prediction unit may generate predictions of the duration, approximate duration, or range of durations for a next idle state. A power management unit may utilize such prediction to determine whether power management actions should be taken, as well as determining the types of power management actions taken.

In some embodiments, a prediction unit may suspend making predictions if the distribution of data does not lend itself to good predictions. For example, if the distribution of idle state durations is relatively even across the bins, then it is less likely that using one of the above methods may yield accurate predictions. In such cases, a prediction unit may suspend making predictions.

If a future distribution of data is more compatible with making accurate predictions, the prediction unit may resume making predictions. Furthermore, a prediction unit may change the methodology upon which predictions are made based on changes in the distribution of data. For example, if distribution of data is similar to that shown in (A) at a first time, and over time shifts to a bimodal distribution as shown in (B), a prediction unit may change its methodology of making predictions to that described above for bimodal distributions. Additionally, prediction units in various embodiments of that described above may be configured to track the accuracy of prior predictions, and may adjust their prediction methodology based on that.

### Prediction Methodologies:

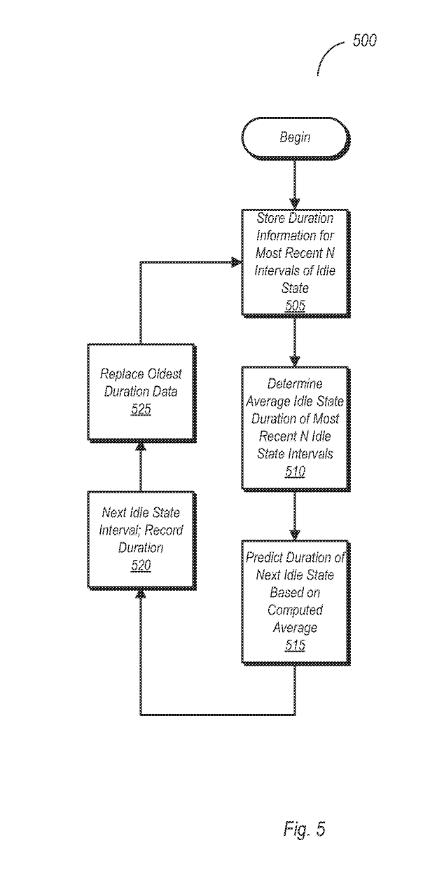

FIGS. 5-9 are flow diagrams illustrating various methodologies for generating a prediction of a duration for a next idle state. Each of the methods discussed below may be performed by various apparatus embodiments as discussed above. In some cases, the methods discussed below may also be performed in part or in full by software.

FIG. 5 is a flow diagram illustrating one embodiment of a method for predicting an idle state duration based on an average. In the embodiment shown, method 500 begins with the storing of duration information for a most recent N intervals of an idle state (block 505). The information stored may include information indication the duration of each of the most recent N intervals. From this information, a histogram such as those discussed above may be generated to indicate the historical distribution of idle state durations for the most recent N intervals. The histogram may include a number of bins, with each bin storing a count of idle state instances having a duration falling within a representative range.

Based on the respective durations of the most recent N idle state intervals, an average duration may be computed (block 510). The method of computing the average may vary, and may be based at least in part on the historical distribution indicated by the histogram. For example, one method of computing the average idle state duration may include filtering out duration data at the extremes and focusing on a center of the distribution.

After computing the average duration, a prediction unit may predict the duration of a next idle state (block 515). In some cases, the prediction may correspond directly to the computed average. In other cases, the prediction may not correspond directly to the average. For example, the prediction may fall within the center of a range of a given bin, even if the computed average is at the upper range of the same bin.

The prediction may be forwarded to a power management unit or a software power management routine. For example, a hardware-based power management unit may utilize the prediction to determine if the predicted duration of the next idle state is great enough to justify the energy and performance costs of entering a low power state. After entering the next idle state, the power management unit may or may not perform power management actions based on the determination made using the prediction.

At some time subsequent to making the prediction, the corresponding functional unit for which the prediction was made will enter the idle state (block 520). Timers may be used to track the duration of the idle state, and may record the final duration value once the functional unit exits the idle state and resumes the active state. In recording the duration data for the most recent idle state, the oldest data (i.e. for the least recent idle state) may be replaced. Method 500 may then return to block 505, storing the duration information for the most recent N instances of the idle state.

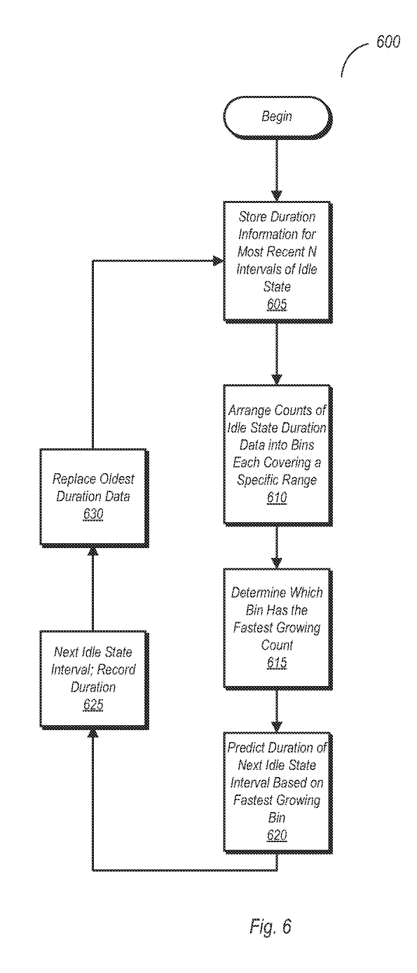

FIG. 6 is a flow diagram illustrating one embodiment of a method for predicting an idle state duration based on a determination of a fastest growing bin. Method 600 begins with storing duration information for the most recent N intervals of the idle state (block 610) and arranging the counts of idle state duration data into bins that each covers a specific range of durations (block 610). After the counts of idle state duration of data for the most recent N intervals has been arranged into bins to form a histogram, a prediction unit may determine which of bins has the fastest growing count (Block 615), based both on the raw count data as well as historical data of the counts in the respective bins. A prediction unit may then predict the duration of the next idle state interval based on which bin has the fastest growing count (block 620). At some point in time subsequent to making the prediction, the functional unit for which the prediction was made will enter the idle state (block 625). After determining that the functional unit is idle, a timer may track the duration of the idle state interval. The final duration of the idle state interval may be recorded upon reentry into the active state by the functional unit. The duration of the just-completed idle state may then be stored, replacing the oldest duration data (block 630). The method then returns to block 605.

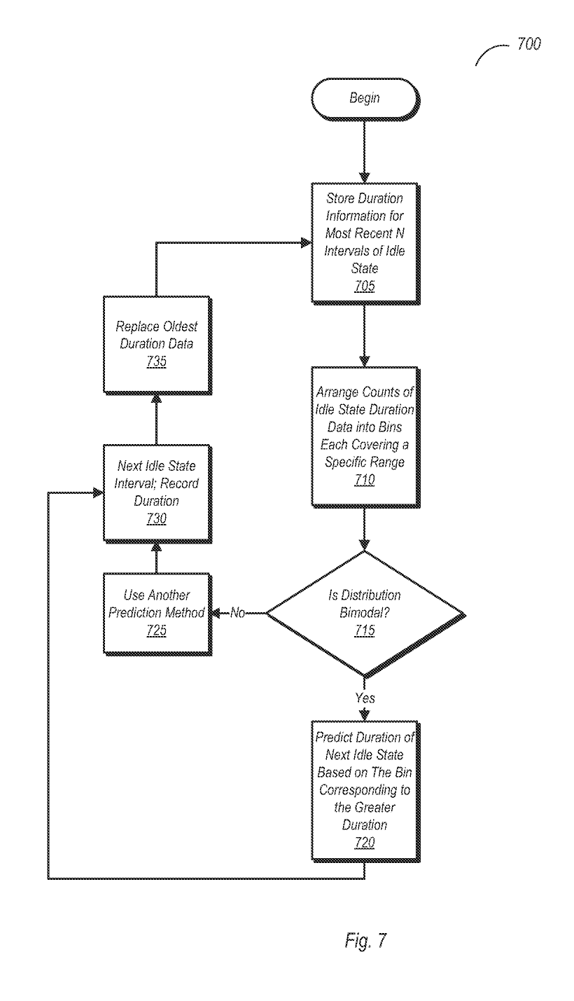

FIG. 7 is a flow diagram illustrating one embodiment of a method for predicting an idle state duration based on a bimodal distribution of idle state durations. Method 700 begins with storing duration information for the most recent N intervals of the idle state (block 705). After the duration information for the most recent N intervals has been stored, the data may be arranged into bins as previously described above (block 710). A prediction unit may then examine the data to determine its distribution. If the distribution of data is determined to be bimodal (block 715, yes), then the prediction unit may predict the duration of the next idle state based on the bin corresponding to the greater idle state duration (block 720). If the distribution is not bimodal (block 715, no), then another prediction methodology may be used (block 725). At a time subsequent to the making of the prediction, the functional unit that is the subject thereof may enter the idle state, and its duration may be recorded (block 730). When the idle state ends, the recorded duration may be stored, replacing the oldest stored duration data (block 735). The method may then return to block 705.

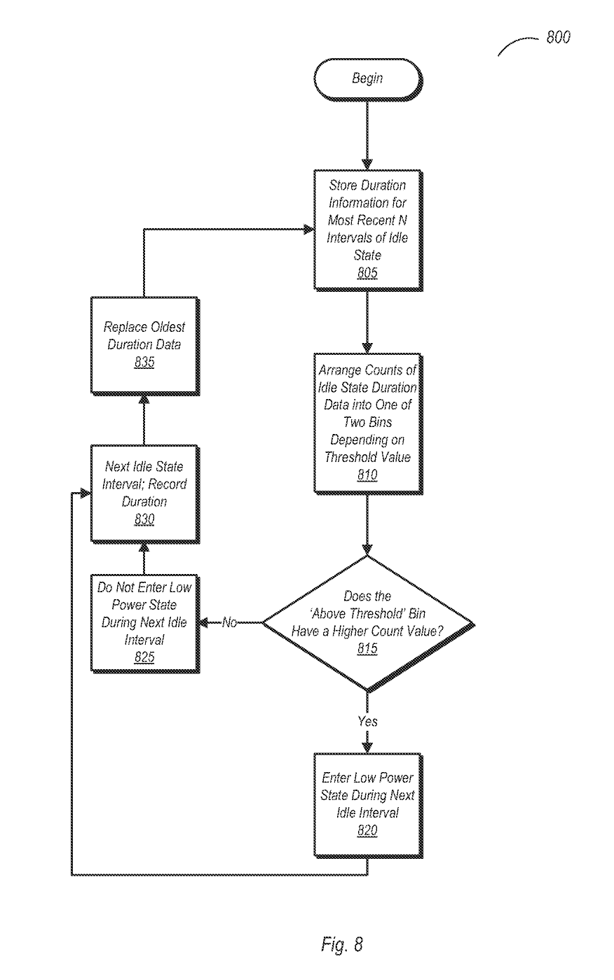

FIG. 8 is a flow diagram illustrating one embodiment of a method for predicting idle state duration based on a pair of bins separated by a threshold. Method 800 begins with the storing of duration data for each of a most recent N intervals (block 805). After the duration data has been stored, it may be arranged into two separate bins, based on a threshold value (block 810). A first bin may include a count of incidents of the idle state having a duration less than a threshold value, while a second bin may include a count of incidents of the idle state having a duration above the threshold value. In one embodiment, the threshold value may be a break-even point above which the energy and performance costs of entering a low power state (e.g., a sleep state) may be justified. The threshold value may be dynamically set in some embodiments, while being a static value in other embodiments. After the data has been arranged into the bins, a determination is made as to whether the count of the ‘Above Threshold’ bin is greater than the ‘Less than Threshold’ bin. If the count of the ‘Above Threshold’ bin is greater (block 815, yes), then the prediction is that the next idle state duration will be greater than the break-even point, and a power management unit may thus cause the corresponding functional unit to enter a low power sate during the next interval of the idle state (block 820). If the count of the ‘Above Threshold’ bin is less than the ‘Less Than Threshold’ bin (block 815, no), then a low power state is not entered during the next interval of the idle state. Irrespective of whether or not a low power state is entered, the duration of the next idle state is tracked and recorded upon its conclusion (block 830), and the this data may replace the oldest stored duration data (block 835) before the method returns to block 805.

Variations of method 800 are possible and contemplated. In one alternate embodiment, an additional threshold based on a difference between the counts of the two bins may be factored in the prediction. As previously noted, the sum of the counts for both bins is N. In an embodiment in which a difference threshold is considered, a predictor may determine if the count value of one of the bins exceeds the count value of the other bin by M, wherein M<N. The embodiment may determine that the low power state is to be entered during the next idle state interval if the count of the ‘Above Threshold’ bin exceeds that of the ‘Less Than Threshold’ bin by M, thereby emphasizing performance over power savings. Alternatively, another embodiment could emphasize power savings over performance by determining that the low power state is to be entered during the next idle state interval if the count of the ‘Less Than Threshold’ bin exceeds the ‘Above Threshold’ bin by less than M, or is actually lower than the ‘Above Threshold’ bin. Another variation on method 800 may incorporate the determination of which of the two bins is growing in number.

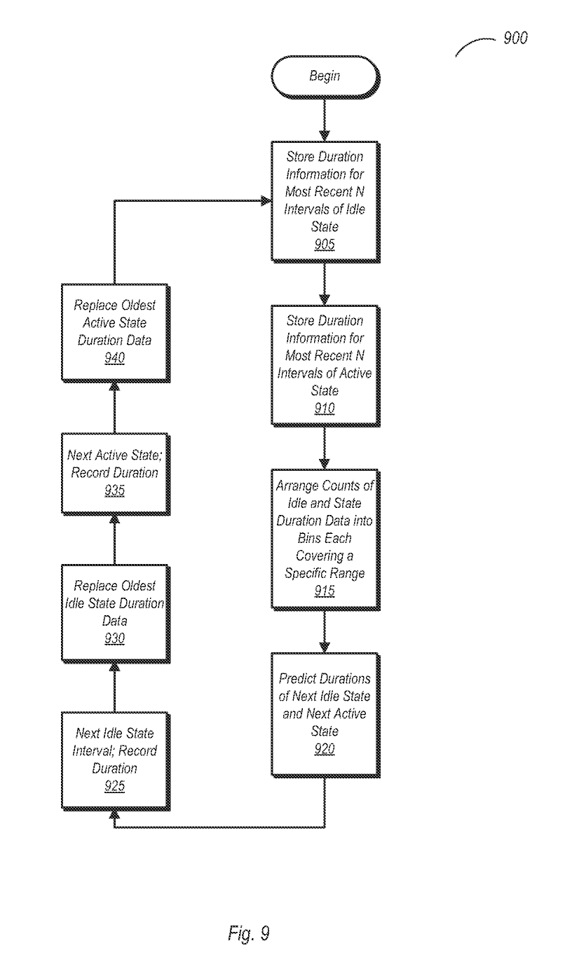

FIG. 9 is a flow diagram illustrating one embodiment of a method for using a binning approach to predict an active time for a functional unit of an IC. In the embodiment shown, method 900 begins with the storing of duration information for each of the most recent N intervals of the idle state (block 905). Additionally, method 900 also includes the storing of duration information for each of a most recent N intervals of the active state (block 910). A first histogram may then be generated for the idle state duration data and a second histogram may be generated for the active state duration data. This may be accomplished by arranging the data into bins each covering a respective range (block 915) as previously described. A prediction unit may then predict a duration of the next idle state using one or more of the various methodologies discussed above, and may also predict the duration of the next active state (block 920). Prediction of the next active state duration may be made using one or more methodologies analogous to those discussed above, or different methodologies not discussed herein.

Method 900 further includes recording the duration of the next idle state interval (block 925), replacing the oldest idle state duration data (block 930), recording the duration of the next active state (block 935), and replacing the oldest active state duration information (block 940), with a return to block 905. Variations of the mechanisms discussed above for recording and storing idle state duration information may also be used to record and store active state duration information.

Predicting the active state information may be useful for obtaining additional power savings, while balancing power savings with performance needs. For example, the predicted duration of a next active state may be used to determine the amount of a cache memory that is to be enabled during the next active state interval. If the next active state interval is predicted to be of a short duration, a small amount of the cache may be enabled, while a larger amount of the cache may be enabled for a longer predicted active state duration.

### Computer Accessible Storage Medium:

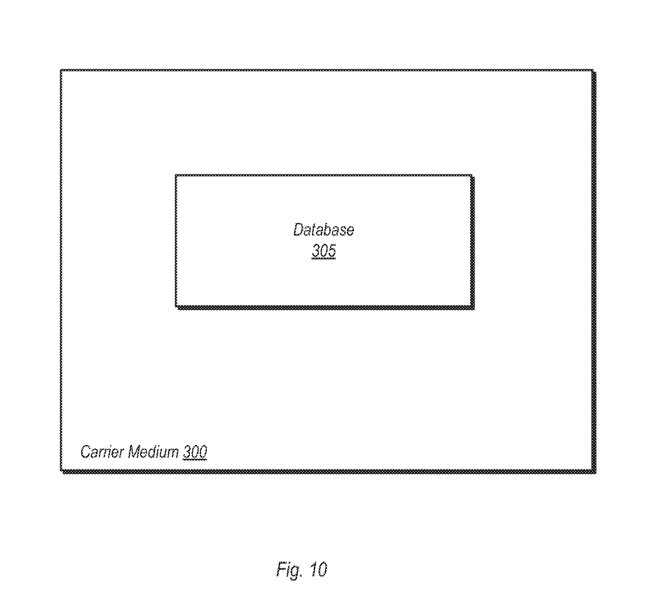

Turning next to FIG. 10, a block diagram of a computer accessible storage medium 400 including a database 405 representative of the system 10 is shown. Generally speaking, a computer accessible storage medium 400 may include any non-transitory storage media accessible by a computer during use to provide instructions and/or data to the computer. For example, a computer accessible storage medium 400 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the database 405 of the system 10 carried on the computer accessible storage medium 400 may be a database or other data structure which can be read by a program and used, directly or indirectly, to fabricate the hardware comprising the system 10. For example, the database 405 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system 10. The netlist may then be placed and routed to produce a data set describing geometric shapes to be applied to masks. The masks may then be used in various semiconductor fabrication steps to produce a semiconductor circuit or circuits corresponding to the system 10. Alternatively, the database 405 on the computer accessible storage medium 400 may be the netlist (with or without the synthesis library) or the data set, as desired. In other alternative embodiments, database 405 may include computer executable instructions/programs and other information that may be used to implement in software, partially or fully, any one or more of the methods (and variations thereof) discussed above with reference to FIGS. 5, 6, 7, 8, and 9.

While the computer accessible storage medium 400 carries a representation of the system 10, other embodiments may carry a representation of any portion of the system 10, as desired, including IC 2, any set of agents (e.g., processing nodes 11, I/O interface 13, power management unit 20, etc.) or portions of agents (e.g., prediction unit 21, activity monitor 212, predictor 218, decision unit 205, etc.).

Numerous variations and modifications will become apparent to those skilled in the art once the above disclosure is fully appreciated. It is intended that the following claims be interpreted to embrace all such variations and modifications.

What is claimed is:

1. A method comprising:
recording a history of idle state durations for a plurality of intervals of an idle state of a functional unit of an integrated circuit (IC), the intervals of the idle states of the functional unit occurring between intervals of an active state of the functional unit; and
predicting a duration of a next interval of the idle state based on the history of idle state durations.

2. The method as recited in claim 1, further comprising subdividing the history of idle state durations into a plurality of bins, wherein each bin is designated to record a count of instances of idle state durations within a specific range.

3. The method as recited in claim 2, further comprising the plurality of bins storing information indicative of the idle state durations for a most recent N intervals of the idle state.

4. The method as recited in claim 3, wherein said predicting comprises computing an average duration for the most recent N intervals of the idle state.

5. The method as recited in claim 3, wherein said predicting comprises determining which of the plurality of bins has fastest increasing count for the most recent N intervals of the idle state.

6. The method as recited in claim 3, further comprising:
recording instances of idle state durations below a threshold value in a first one of the plurality of bins;
recording instances of idle state durations above the threshold value in a second one of the plurality of bins; and
predicting whether the duration of the next interval of the idle state is greater than or less than the threshold value based on which of the first and second bins has a greater count of instances of idle state durations within its specified range.

7. The method as recited in claim 1, further comprising predicting a duration of a next interval of the active state based on the history of idle state durations.

8. The method as recited in claim 1, further comprising determining whether to enter a low power state based on said predicting the duration of the next idle state.

9. The method as recited in claim 8, wherein the low power state is a sleep state in which power is removed from the functional unit.

10. The method as recited in claim 9, further comprising exiting the sleep state at a predetermined time after entering the sleep state, wherein the predicted time is based on the predicted duration of the idle state.

11. An integrated circuit comprising:
a functional unit configured to cycle between intervals of an active state and intervals of an idle state; and
a prediction unit configured to record a history of idle state durations for the for a plurality of intervals of the idle state and further configured to predict a duration of the next interval of the idle state based on the history of idle state durations.

12. The integrated circuit as recited in claim 11, wherein the prediction unit includes a storage unit configured to store the history of idle state durations in a plurality of bins, wherein each bin is designated to record a count of idle state durations within a specific range.

13. The integrated circuit as recited in claim 12, wherein the storage unit is configured store, within the plurality of bins, information indicative of idle state durations for a most recent N intervals of the idle state.

14. The integrated circuit as recited in claim 13, wherein the prediction unit is configured to predict the duration of the next idle state based on an average duration of the most recent N intervals of the idle state.

15. The integrated circuit as recited in claim 13, wherein the prediction unit is configured to predict the duration of the next idle state based on which of the plurality of bins has a fastest increasing count for the most recent N intervals of the idle state.

16. The integrated circuit as recited in claim 13, wherein the prediction unit is configured to:
record instances of idle state durations below a threshold value in a first one of the plurality of bins;
record instances of idle state durations above the threshold value in a second one of the plurality of bins; and
predict whether the duration of the next idle state will be greater or less than the threshold value based on which of the first and second bins has a greater count of instances of idle state durations within its specified range.

17. The integrated circuit as recited in claim 11, wherein the prediction unit is further configured to predict a duration of a next active state based on the history of idle state durations.

18. The integrated circuit as recited in claim 11, further comprising a power management unit configured to determine whether to place the functional unit in a low power state based on a prediction of the duration of the next idle state.

19. The integrated circuit as recited in claim 18, wherein the low power state is a sleep state in which the power management unit removes power from the functional unit.

20. The integrated circuit as recited in claim 19, wherein the power management unit is configured to cause the functional unit to exit the sleep state at a predetermined time subsequent to entering the sleep state, wherein the predetermined time is based on a prediction of the duration of the next idle state.

21. A system comprising:
a plurality of processor cores implemented on a system-on-a-chip (SoC), wherein each of the plurality of processor cores is configured to cycle between intervals of an active state and an idle state; and
a prediction unit implemented on the SoC and configured to, for each of the plurality of processor cores, record a corresponding history of idle state durations and further configured to predict a duration of the next interval of the idle state for each of the plurality of processor cores based on their respective histories of idle state durations.

22. The system as recited in claim 21, wherein the prediction unit includes a storage unit configured to store, for each of the plurality of processor cores, the corresponding history of idle state durations in a respective plurality of bins, wherein each bin is designated to record a count of idle state durations within a specific range.

23. The system as recited in claim 22, wherein the storage unit is configured to store, within the respective plurality of bins for each processor core, information indicative of idle state durations for a most recent N intervals of the idle state for that processor core.

24. The system as recited in claim 23, wherein the prediction unit is configured to, for a given processor core, predict the duration of its next idle state based on an average duration of the most recent N intervals of the idle sate for the given processor core.

25. The system as recited in claim 23, wherein the prediction unit is configured to, for a given processor core, predict the duration of the next idle state based on which of the plurality of bins for the given processor core has a fastest increasing count for the most recent N intervals of the idle state.

26. The system as recited in claim 23, wherein the prediction unit is configured to:
record, for a first processor core, instances of idle state durations below a threshold value in a first one of a corresponding plurality of bins;
record, for the first processor core, instances of idle state durations above the threshold value in a second one of the corresponding plurality of bins; and
predict whether the duration of the next idle state of the first processor core will be greater or less than the threshold value based on which of the corresponding first and second bins has a greater count of instances of idle state durations within its specified range.

27. The system as recited in claim 21, wherein the prediction unit is further configured to predict a duration of a next active state for a given processor core based on the history of idle state durations for the given processor core.

28. A computer readable storage medium comprising a data structure which is operated upon by a program executable on a computer system, the program operating on the data structure to perform a portion of a process to fabricate an integrated circuit including circuitry described by the data structure, the circuitry described in the data structure including:
a functional unit configured to cycle between intervals of an active state and intervals of an idle state; and
a prediction unit configured to record a history of idle state durations for the for a plurality of intervals of the idle state and further configured to predict a duration of the next interval of the idle state based on the history of idle state durations.

29. The computer readable storage medium as recited in claim 28, wherein the prediction unit described in the data structure includes a storage unit configured to store the history of idle state durations in a plurality of bins, wherein each bin is designated to record a count of idle state durations within a specific range.

30. The computer readable storage medium as recited in claim 28, wherein the circuitry described in the data structure includes a power management unit configured to determine whether to place the functional unit in a low power state based on a prediction of the duration of the next idle state.
